(19) United States
(12) Patent Application Publication
(10) Pub. No.: US 2022/0205923 A1
(43) Pub. Date: Jun. 30, 2022

(54) Device and Method for Determining an Elemental Composition of Ground

(71) Applicant: DEERE & COMPANY, Moline, IL (US)

(72) Inventors: Michael Schüngel, Düsseldorf (DE); Daniela Vogt, Berthelsdorf (DE)

(21) Appl. No.: 17/601,102

(22) PCT Filed: Mar. 25, 2020
(86) PCT No.: PCT/EP2020/058388

§ 371 Date: Oct. 4, 2021

(30) Foreign Application Priority Data
Apr. 5, 2019 (DE) 10 2019 109 052.0

(51) Int. Cl. G01N 21/71; G01N 21/359

(52) U.S. Cl. CPC G01N 21/718; G01N 21/359

(57) ABSTRACT

A method for determining an elemental composition of ground (1) according to the depth (t), includes taking a core sample (2) of the ground (1), and determining the elemental composition of the ground (1) according to the depth (t) by analysing the core sample (2) taken by laser-induced breakdown spectroscopy. It is possible to analyse ground (1), for example, a field used for agriculture or a building ground to be examined for pollutants. The quality of the ground (1) can be determined by PGNAA, PFTNA and/or LIBS Prompt Gamma Neutron Activation Analysis, Pulsed Fast Neutron Activation Analysis and/or Laser Induced Breakdown Spectroscopy.

The present invention relates to devices and methods for determining an element composition in a ground, in particular in an agricultural, geogenic or anthropogenic ground or soil. The invention is directed to a method for determining the element composition of the ground depending of the depth and to a method for determining the element composition of the ground and to corresponding devices. In addition, the invention is directed to a method for treating an agriculturally used soil using a determined element composition of the soil.

In particular in agriculture, there is a need to know the composition of the soil to be cultivated because the composition has a considerable influence on plant growth. It is known from the prior art to determine the composition of an agriculturally used soil by sampling and analyzing the sample. The analysis usually takes place in a laboratory in a time-spaced manner from the sampling. This procedure is complex and expensive. In addition, this procedure is inaccurate insofar as the soil surface quality can only be examined locally on a random basis. The information density obtained thereby is thus very low. Various methods are known from the prior art for facilitating the removal of samples. Thus, finer screening of the sample removal is intended to be made possible and to this extent a more accurate analysis of the soil quality is intended to be made possible. Despite such developments, however, it has hitherto not been possible to analyze an agriculturally used soil in a reliable manner with regard to its composition. Furthermore, laboratory investigations have the disadvantage that they typically imply, that several days can lie between a sampling and, for example, a fertilization of an agriculturally used soil based on the results of that analysis. Therefore, based on known methods for analyzing the soil quality, only an inaccurate fertilization of the soil is accomplishable. In particular, it is not possible to efficiently compensate inhomogeneities in the composition of a soil by targeted fertilization. The consequence can in particular be an overfertilization or an undersupply of the soil.

A similar need exists for a variety of other applications. Thus, it is regularly necessary to examine anthropogenic grounds, such as for example in landfills, for pollutants. This is also necessary in the context of geological exploration bores, for example for deposit development, for groundwater development or for building ground investigation. The standardized procedure in geological and anthropogenic drilling operations for grounds is to carry out analyses on the basis of a grid and to analyze ground samples obtained in that process in a laboratory. This type of analysis is carried out in laboratories for environmental analysis or in specialized institutes of universities or research facilities, and is usually very complex. An area-wide, reliable analysis of the material composition is not possible according to the prior art, which is similar to the situation for agricultural soils.

Based on this, the object of the present invention is to at least partially overcome the problems known from the prior art and, in particular, to provide methods and devices by means of that the quality of a ground can be retrieved particularly efficiently and reliably in an area-covering or area-wide manner.

This object is achieved by virtue of the features of the independent claims. Further advantageous embodiments of the invention are specified in the dependent claims. The features individually listed in the dependent claims can be combined in a technologically meaningful manner and can define further embodiments of the invention. In addition, the features specified in the claims are described and explained in more detail in the description, wherein further preferred embodiments of the invention are illustrated.

According to the invention, a method for determining an element composition of a ground depending of (or as a function of) the depth is presented. The method comprises:
extracting a core sample of the ground, and
determining the element composition of the ground depending on the depth by analyzing the extracted core sample by means of Laser induced Breakdown Spectroscopy, LIBS.

With the described method, a ground can be characterized in an automated manner. For this purpose, in particular the element composition of a ground can be determined using the described method. This means the distribution of the chemical elements in the ground. The element composition may also be referred to as the distribution of element concentrations. The chemical bonding state of the elements does not matter here. The element composition is an important quality parameter in many applications. The determination of the element composition can also be referred to as multi-element analysis.

The described method is preferably applied to an agricultural soil, such as, for example, an agricultural area or a forestry surface.

Alternatively, the described method can also be applied to anthropogenic grounds such as, for example, a landfill. The described method can also be used in the context of geological exploration bores, for example for development/exploration of deposits, for groundwater development/exploration or for building ground investigations. In this case, with the described method, the raw material recovery potential of a ground can be determined, the solubility potential of environmentally relevant substances in the ground water closure can be monitored or the use potential of a building surface, such as, for example, a former landfill, can be determined. It is also applicable in the deconstruction of industrial installations, such as for example gas stations, to evaluate a possible contamination of the ground. With the method described, time delays can be avoided caused by laboratory examinations. Optionally required additional examinations can thus be carried out in a simple manner, because the necessity thereof can be immediately recognized.

With an automated device mounted on a vehicle for larger depths, natural substrates and anthropogenic substrates can be systematically analyzed in real time and in 3D with regard to pollutant and valuable substance concentrations, such as, for example, from landfills, tank sites/gas stations or industrial plants. The fact that the device is described as being mounted “on” a vehicle shall not limit the type and position of the arrangement of the device on the vehicle. Thus, the term “on” shall in particular comprise that the device is attached to, below, in front of, to the rear at or laterally on the vehicle.

With the described method, the quality of the ground in the form of the element composition can be determined particularly efficiently and reliably. Hereto, samples of the ground are removed and analyzed by means of LIBS. LIBS has the advantage that an analysis of the samples taken can thus be carried out in situ, i.e., directly at the location of the removal/extraction of the sample. The samples can thus be analyzed particularly quickly.

With the method described, the element composition can be determined depending of the depth of the ground. In this context, depth is understood as a distance between the ground surface and a point under consideration within the ground. This can be referred to as “depth”. A depth of 1 m describes, for example, a point of one meter below the ground surface.

The core sample is preferably taken vertically. This means that an axis of the core sample is vertically aligned prior to removal or extraction of the core sample. It is also possible for the core sample to be removed from the vertical in a tilted manner.

Depending on the application, the method can cover different depth ranges. In the field of agriculture, a maximum depth of 1 m can be sufficient because the roots of agriculturally used plants usually do not reach deeper into the soil. In the case of anthropogenic influenced grounds, and in particular in the case of geologic exploration bores, considerably larger depths can be investigated.

The depth-dependent determination of the element composition is possible in the method described by taking the samples in the form of core samples. In this context, a core sample is to be understood as a sample which is used, for example, in the form of a drill core. In the case of an application of the described method to geological exploration bores, a drill core obtained during a bore procedure also represents a core sample.

A core sample is a sample representative of a particular depth range of the ground. Thus, the depth-dependent element composition of the ground can be determined on the basis of the core sample. The core sample is preferably removed by means of a probe such as a ramming core probe, in particular by means of a so-called “Pürckhauer”. A ramming core probe is a device with which a typically cylindrical core sample can be extracted from the ground. The core sample preferably extends from the ground surface up to a depth of 0.5 m, preferably even up to a depth of 1 m. Such depth cover is particularly well suited for many applications, particularly in agriculture. The longitudinal extent of the core sample, in particular corresponding to the length of the probe used for sampling, determines over which depth range the element composition of the ground can be determined by means of the described method. As a result of the removal or extraction of core samples, the method described has the advantage that not only an analysis of the surface of the ground takes place. The core samples are preferably removed in an automated manner. This means that a device for taking samples is used which, after switching on and setting, automatically removes or extracts the core samples. This can reduce the outlay for carrying out the described method or, alternatively, make it possible to use a higher number of samples under a constant outlay.

Preferably, the element composition of the ground is determined depending on the depth by direct analysis of the removed core sample by means of Laser Induced Breakdown Spectroscopy, LIBS. Here, “direct” means that LIBS is applied directly to the core sample.

When the core sample is removed or extracted, the position of the removal is preferably determined, for example by GPS. In particular in connection with an autonomically driving vehicle, the position determination can also take place by means of the 5G mobile radio network. As a result, a two-dimensional or three-dimensional model of the ground can be created when a plurality of core samples are removed from the respectively recorded measurement data, for example by interpolation between the removal locations. Thus, a depth model of the ground is obtained.

The removed or extracted core sample is analyzed by means of LIBS. Thereto, the core sample is scanned or sampled along its length with a laser. The result is an element composition as a function of the position along the core sample and insofar as a function of the depth of the ground.

It is possible that the core sample can be stored after removal and then subsequently analyzed by means of LIBS. This has the advantage that no special requirements, in particular in size and shape, have to be provided to the device used for the LIBS.

Preferably, a fresh cut of the core sample is analyzed. For this purpose, for example, the outermost 5 mm of the core sample can be peeled off in the radial direction by means of a ridge. This can follow the extraction and/or thereafter. In the analysis by means of LIBS, smearing effects can thus be avoided, in particular by entrainment during removal.

The core sample can also be analyzed without peeling. This is possible, in particular, if smearing effects occur only to a small extent and/or if only a low accuracy with respect to the depth dependence is required.

Alternatively, according to a preferred embodiment of the method, the core sample is analyzed during the removal/extraction.

In this embodiment, a LIBS device is preferably used which is designed and arranged in such a way that the core sample is guided past the LIBS device when it is pulled out of the ground. It is also preferred in this embodiment that the analysis is made at a fresh section or cut.

The analysis of the core sample during removal/extraction has the advantage that the sample can be deposited immediately after the removal, without the necessity for paying attention that individual parts of the core sample could shift or mix. If this would happen, it would not be possible to obtain a correct depth dependence upon subsequent analysis. In particular in the case of a core sample in the form of a drill core of a geological exploration bore, the placement of the drill core can also be made more difficult or even impossible for reasons of space. According to the present embodiment, however, the core sample is already analyzed during removal/extraction from the ground, so that careful placement of the entire core sample is not required.

Furthermore, by the present embodiment the described method is accelerated. During removal of the core sample from the ground, a plurality of measurements are preferably made, preferably 10 to 50 measurements per second. The core sample can thus be analyzed with a high spatial resolution, so that the element composition can be determined with a correspondingly high-resolution dependence.

In addition to the element composition, further parameters of the ground can be determined, for example by means of optical cameras, infrared analysis, NIR, radar measurement, microwave measurement, ultrasonic measurement and/or gamma ray backscattering and absorption.

As a further aspect, a device for determining an element to be collected of a ground depending from the depth is provided. The apparatus comprises:
a device for extracting or removing a core sample of the ground,
a LIBS device for determining the element composition of the ground depending form the depth by analysis of the removed core sample by means of Laser induced Breakdown Spectroscopy, LIBS.

The described particular advantages and design features of the method for determining the element composition of the ground depending from the depth can be applied and transmitted to the device for determining the element composition of the ground depending of the depth, and vice versa. In particular, the described method is preferably carried out using the described device. In particular, the described device is preferably configured to carry out the described method.

The LIBS device is preferably configured in such a way that the core sample can be analyzed during the removal/extraction.

As a further aspect, a method for determining an element composition of a ground is presented. The method comprises:
a) for at least one sample location of the ground depending form the depth by means of the method described above, and/or
b) for a scanning surface, the ground is analyzed by scanning the ground by means of Prompt Gamma Neutron Activation Analysis, PGNAA, and/or Pulsed Fast Neutron Activation Analysis, PFTNA, and
c) determining the element composition of the ground from the results of step a) and/or b).

The described special advantages and design features of the method described above and the corresponding device for determining the element composition of the ground depending form the depth can be applied and transferred to the method described here for determining the element composition of the ground, and vice versa. This applies, in particular, to the extent that step a) of the method described in the present case is concerned. In particular, the special features of step b) are described below.

The result of the described method is preferably a profile of the element composition of the ground. Such a profile is preferably dependent on location and depth and in this respect three-dimensionally. The depth dependence can be achieved by step a). However, a two-dimensional profile can also be created, which is merely location-dependent and comprises a value for each location. Such a profile can also be created without step a). However, a two-dimensional profile can also be obtained, for example, by projecting the values of a three-dimensional profile.

On the basis of the profile obtained, for example, the pollutant concentration in anthropogenic influenced grounds can be detected. This may make it easier for operators of such grounds to meet mandatory regulatory requirements. Thus, in particular, environmental parameters can be systematically captured. On the basis of this, damages for grounds and waters may be minimized.

Furthermore, the profile obtained can serve to draw conclusions about the development of the ground in particular with other parameters.

In the method described, steps a) and c) can be carried out without step b), steps b) and c) without step a) or steps a), b) and c). In the latter case, steps a) and b) can be carried out in any sequence completely or partially simultaneously or sequentially. Step c) begins in any case only after the beginning of step a) and/or b). However, it is possible that step c) is carried out partially or completely parallel to steps a) and/or b).

In step a), the method described above for determining the element composition of the ground is carried out depending from the depth for at least one sample location, preferably for a plurality of sample locations. The sample locations are preferably arranged on the basis of a grid and distributed over the whole ground.

In step b), the ground is analyzed by means of PGNAA and/or by means of PFTNA. The element composition of an upper ground layer can be obtained by means of PGNAA and/or PFTNA. The element composition can be obtained in the form of average values which are formed, for example, in each case over the 50 cm of the ground immediately below the ground surface.

The analysis by means of PGNAA is preferred. The two methods mentioned are methods for analysis using neutrons. This Neutrons can be emitted into the ground starting from a neutron source, for example a suitable radioactive material. Within the ground, there is an interaction between these neutrons and the nuclei of the atoms forming the ground. In this core interaction, gamma radiation is generated which can be detected by a radiation detector. On the basis of the detected radiation, it is possible to infer the atoms present in the ground. In this respect, the element composition of the ground can be determined. This can take place in a area-wide manner, in which a corresponding device is moved over the ground in such a way that the ground is continuously scanned. Alternatively, it is possible to carry out individual measurements, for example at points of a grid, and to interpolate the results.

In particular, a scanning unit which has a neutron source and a radiation detector can be used for step b). The scanning unit is preferably brought into the vicinity of the ground surface with a carriage or a lifting device and moved over it. The scanning unit can also be mounted on a plough, so that the device can be introduced into depressions of the ground.

In step c), the element composition the ground is determined from the results of step a) and/or b).

If, in addition to step c), only step a) is carried out, step c) is carried out on the basis of the results from step a). For this purpose, the results from step a) can be supplemented, for example, by interpolation between the sample locations to form an area-wide profile of the element composition. This profile can be location-dependent and depth-dependent and in this respect be three-dimensional.

If, in addition to step c), only step b) is carried out, step c) is carried out on the basis of the results from step b). Since the element composition of the ground can be determined by means of PGNAA and/or by means of PFTNA in the form of average values, step c) may consist, for example, of bringing the result of step b) into the form of a gapless two-dimensional element distribution map of the ground.

However, the embodiment of the method according to which both step a) and step b) are carried out in addition to step c) is preferred. In step c), the element composition of the ground is created starting from the result of step a) and with correction on the basis of the result of step b) or by the result of step b) and with correction on the basis of the result of step a).

In this embodiment, the advantages of the analysis methods set out in steps a) and b) are combined with one another. With the linking of the methods, the analytical advantages of the respective method are integrated into an overall system with a particularly high measuring potential.

By means of PGNAA and/or PFTNA, the element composition of the ground can already be determined in a surface-covering or area-wide manner. In this respect, it can be sufficient to use only this method. However, the accuracy of PGNAA and PFTNA is limited. In addition, these methods are sensitive only to certain elements.

A higher measuring accuracy can be achieved by means of LIBS than with PGNAA and/or PFTNA. Also, more elements can be analyzed with LIBS than with PGNAA and/or PFTNA. However, LIBS is more complex than PGNAA and/or PFTNA as a result of the required sample extraction. However, analysis of core samples by means of LIBS is—unlike an analysis by means of PGNAA and/or PFTNA—information-rich with respect to the element spectrum and the depth dependency.

Therefore, according to the present embodiment, a model of the element composition of the ground is created by means of PGNAA and/or PFTNA and corrected on the basis of the LIBS, or vice versa. By correcting it is to be understood that in step c) the element composition of the ground is determined in such a way that—insofar as possible—the values obtained with the two different measurement methods coincide with one another. Instead of interpolated values, the element composition determined in step c) can comprise values which are based on the results of the PGNAA and/or PFTNA between the sample locations.

According to a further preferred embodiment of the method, a profile of the element composition of the ground is created which covers the ground from a ground surface to a depth in the range from 0.3 to 1 m.

It has been found that the specified depth coverage for many applications is a suitable compromise between the measurement accuracy, the actual effort and the knowledge of the element composition required for the particular application in certain depths. Average values for maximum depths in the range from 0.3 m to 0.5 m can be obtained by means of PGNAA and/or PFTNA. If a profile of the element composition of the ground is created together with LIBS, this can be particularly accurate up to a depth in the range of 0.3 m and can have sufficient accuracy for many applications up to a depth of 1 m.

The present embodiment is particularly suitable for agricultural soils. In particular in the analysis of anthropogenic affected grounds and geological exploration wells by means of LIBS, considerably larger depths can be relevant as described above.

According to a further preferred embodiment of the method, a moisture of the ground is additionally determined in step a) and/or b) and is taken into account in the determination of the element composition of the ground.

The water content in the ground may have an influence on the neutron flux through the ground. By knowing the moisture of the ground, the accuracy of the LIBS, PGNAA and/or the PFTNA can therefore be improved. The moisture of the ground can be determined, for example, by means of microwave technology, near-infrared technology, gamma backscatter, measurement of the capacitive resistance, or by terahertz measurement technique. Preferably, the moisture is determined in a depth dependent manner. This can take place, in particular, during the removal of a core sample.

According to a further preferred embodiment of the method, at least one parameter of the ground is further determined by means of near-infrared spectroscopy, NIR, and/or by means of a camera.

The measurement accuracy of the measuring method can be increased by NIR. For this purpose, in addition to LIBS, PGNAA and/or PFTNA, the depth dependent additional information of the ground can also be determined by means of NIR as a parameter of the ground and compared with the results obtained by LIBS, PGNAA and/or PFTNA. As an overall result, a corrected element combination can be determined, for example in which the result of the LIBS, PGNAA and/or PFTNA is corrected and/or calibrated on the basis of the result of the NIR.

Furthermore, by means of NIR, further parameters of the ground such as, for example, a water content of the ground and/or a proportion of certain organic compounds in the ground can be determined. These parameters are preferably determined in a depth dependent manner. Alternatively, it is preferred to determine these parameters independently, for example as average values via a core sample and/or by direct analysis of the surface of the ground.

The camera is preferably a high-performance camera. Preferably, the camera has such a high resolution that properties of the ground can thus be determined optically. Using the camera, parameters of the ground, such as, for example, a cohesivity of the ground, a grain size distribution pattern and/or a portion of clay in the ground can be determined. These parameters are determined in a particularly depth dependent manner, for example by analysis of a core sample. With the camera, the core sample is preferably analyzed during removal/extraction. Thus, the surface of the core sample can be analyzed without the camera having to be moved. Alternatively, it is preferred to determine these parameters in a depth dependent manner, for example as average values via a core sample and/or by direct analysis of the surface of the ground.

According to a preferred embodiment of the method, the ground is an agricultural soil.

The profile obtained with the described method can be used for systematic monitoring of agricultural areas, forestry surfaces and natural areas. In this way, a regulatory required monitoring for environment and/or water protection can be facilitated.

As a further aspect, a device for determining an element composition of a ground by means of the above-described method is provided. The apparatus comprises:
a sample unit for extracting and analyzing core samples according to step a), and/or
a scanning unit for scanning the ground according to step b), and
an evaluation device which is configured to determine the element composition of the ground according to step c).

The described special advantages and design features of the method and of the device for determining the element composition of the ground depending on the depth and of the previously described method for determining the element composition of the ground can be applied and transmitted to the device for determining the element composition of the ground, and vice versa. In particular, the method described above is preferably carried out using the device described in the present case. In particular, the device described in the present case is preferably configured for carrying out the above-described method.

The device preferably comprises both a sample unit and a scanning unit, so that both step a) and step b) can be carried out. In the case, the evaluation device is preferably set up to create, in step c), the profile of the element composition of the ground starting from the result of step a) and with correction on the basis of the result of step b) or vice versa.

The sample unit and/or the scanning unit are preferably configured to analyze the ground from a ground surface to a depth in the range from 0.3 to 1 m.

Preferably, the device further comprises a device for determining the moisture of the ground. In this case, the evaluation device is preferably configured to take into account the moisture during the determination of the element composition of the ground. The device for determining the moisture of the ground is preferably arranged in such a way that the moisture of the ground can be determined in a depth dependent manner when a core sample is removed. The device for determining the moisture of the ground can in particular be part of the sample unit.

The device preferably further comprises a device for determining at least one parameter of the ground by means of near-infrared spectroscopy (NIR), and/or by means of a camera. Preferably, the camera is arranged in such a way that the ground with the camera can be analyzed in a depth dependent manner when a core sample is removed. The camera can in particular be part of the sample unit.

As a further aspect, a method for treating an agricultural soil is presented. The method comprises:
A) determining an element composition of the soil by means of one of the methods described above, and
B) location-dependent application of a fertilizer to the ground based on the result from step A).

The described special advantages and design features of the method and of the device for determining the element composition of the soil depending form the depth and of the method and of the device for determining the element composition of the soil can be applied to the method for treating the soil used in agriculture and is portable, and vice versa.

In step A), the element composition of the soil is determined on the basis of the described method for determining the element composition of the soil depending form the depth or on the basis of the method for determining the element composition of the soil. The information obtained in this way can be used to fertilize the ground as required. By location-dependent application of a fertilizer according to step B), a homogenization of the element composition in the ground can be sought. A homogeneous soil quality can thus be achieved, which can promote a homogeneous quality of agricultural products obtained with the soil. Suitable fertilizers are, in particular, lime/mineral material fertilizers and/or organic fertilizers. The location-dependent application of the fertilizer in step B) is preferably carried out in an automated manner, in particular by means of GPS or 5G.

The invention and the technical environment are explained in more detail below on the basis of the figures. It should be pointed out that the invention is not intended to be limited by the exemplary embodiments shown. In particular, unless explicitly stated otherwise, it is also possible to extract partial aspects of the substantive matter explained in the figures and with other components and knowledge from the present description and/or figures can be combined. In particular, it should be pointed out that the figures and in particular the illustrated size ratios are only schematic. Identical reference signs designate identical objects, so that explanations from other figures can be used in addition. The figures show the following:

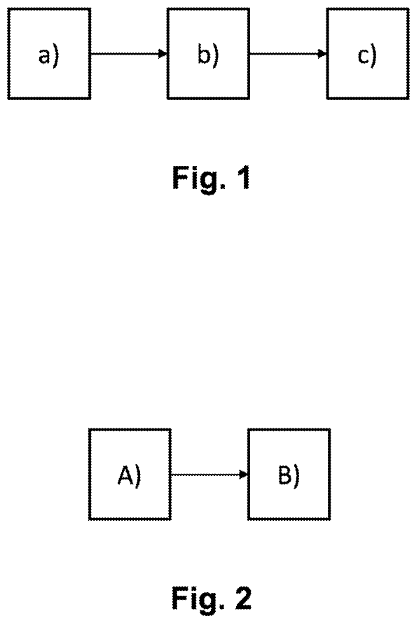

FIG. 1: shows a schematic sequence of a method according to the invention for creating a profile of an element composition of a ground,

FIG. 2: shows a schematic sequence of a method according to the invention for treating an agriculturally used soil,

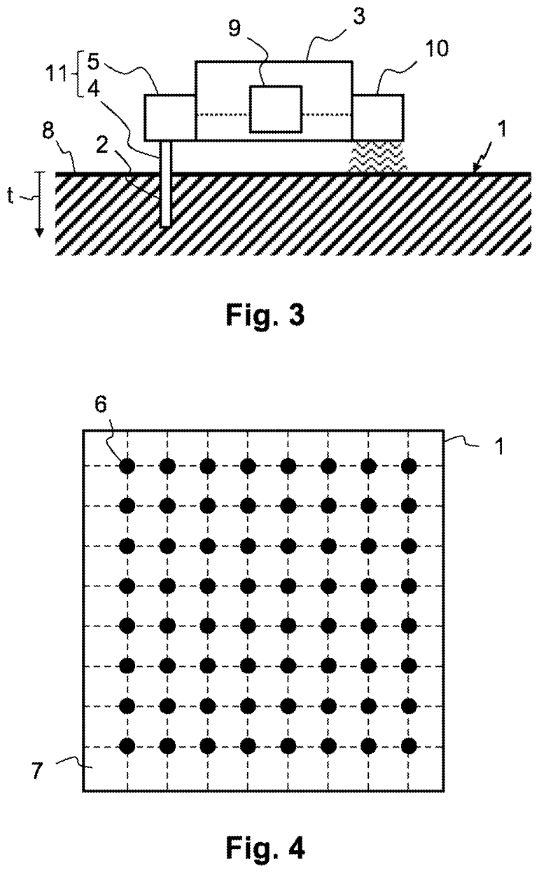

FIG. 3: shows a schematic side view of a device according to the invention on a ground,

FIG. 4: shows a schematic plan view of a soil to be analyzed according to the invention, and

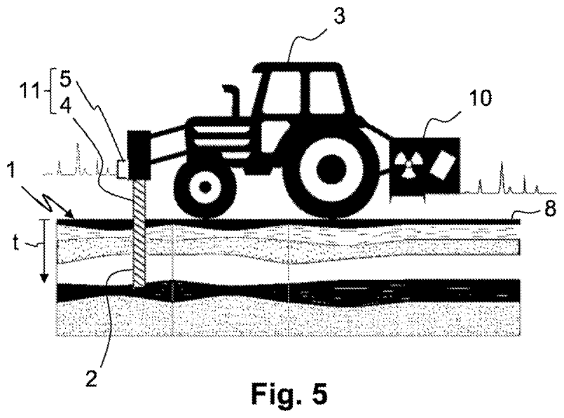

FIG. 5: shows a schematic side view of a further embodiment of the apparatus according to the invention on a soil.

FIG. 1 shows a schematic sequence of a method for creating a profile of an element composition of a ground 1. The reference signs used relate to FIGS. 3 and 4. The method comprises:
a) for at least one sample location 6, the soil 1 is analyzed depending form the depth t. For this purpose, an element composition of the ground 1 is determined as a function of the depth t by:
   extracting (or removing, gathering) a core sample 2 of the ground 1 at the sample location 6,
   and
   determining the element composition of the ground 1 depending of the depth t by analysis of the extracted core sample 2, by Laser induced Breakdown Spectroscopy, LIBS, during the extraction of the core sample 2,
   and
b) for one scanning surface 7, analyzing the ground 1 by means of scanning the ground 1 by means of Prompt Gamma Neutron Activation Analysis, PGNAA, and/or Pulsed Fast Neutron Activation Analysis, PFTNA, and
c) determining the element composition of the ground 1 from the results of step a) and b). For this purpose, a profile of the element composition of the ground 1 can be created on the basis of the result of step b) and with correction on the basis of the results of step a), or vice versa. The resulting profile of the element composition covers the ground 1 from a bottom surface 8 to a depth t in the range from 0.3 to 1 m.

In addition, in step a) and/or b), a moisture of the ground 1 is determined and taken into account in the determination of the element composition of the ground 1.

Furthermore, at least one parameter of the ground 1 is determined by means of near infrared spectroscopy (NIR) and/or by means of a camera.

The method can in particular be applied to an agricultural soil.

FIG. 2 shows a schematic sequence of a method for treating an agricultural soil 1. The method comprises:
A) determining an element composition of the soil 1 by means of the method of FIG. 1 and
B) location-dependent application of a fertilizer to the soil 1 on the basis of a value from step A).

FIG. 3 shows a device 3 with which the method described in FIG. 1 can be carried out. The device 3 can be used in the method according to FIG. 2 in step A). The device 3 is shown on a bottom surface 8 of a ground 1.

The device 3 is set up to determine an element composition of a ground 1 depending from the depth t. For this purpose, the device 3 comprises a device 4 for removing a core sample 2 of the ground 1 and a LIBS device 5 for determining the element composition of the ground 1 depending from the depth t by analysis of the removed core sample 2 by means of Laser induced Breakdown Spectroscopy, LIBS. The device 4 for removing/extracting a core sample 2 of the ground 1 preferably comprises an element (not shown) for peeling off the core sample 2.

The device 3 is furthermore configured to determine the element composition of the ground 1. To this extent, the device 4 for removing a core sample 2 of the ground 1 and the LIBS device 5 can be regarded as a one unit 11 for removing and analyzing core samples 2 according to step a) of the method from FIG. 1. The sample unit 11 can comprise a broad analysis such as, for example, a camera, a moisture meter and/or an NIR device. In addition, the device 3 comprises a scanning unit 10 for scanning the ground 1 according to step b) of the method from FIG. 1. Furthermore, the device 3 comprises an evaluation device 9, which is designed to determine the element composition of the ground 1 according to step c) of the method from FIG. 1.

FIG. 4 shows a schematic plan view of a soil 1, which can be analyzed by means of the method from FIG. 1, in particular by means of the device 3 from FIG. 3, and/or which can be treated by means of the method from FIG. 2. A plurality of sample locations 6, which are arranged according to a grid represented by dashed lines, are shown. At the sample locations 6 core samples 2 are removed/extracted for analysis by means of LIBS according to the method according to FIG. 1. Furthermore, a scanning surface 7 is shown. This comprises the entire surface of the rectangle with a solid line, that is to say the entire soil 1. For the scanning surface 7, the element composition of the soil 1 is determined in accordance with the method from FIG. 1 by scanning the soil 1 by means of PGNAA and/or PFTNA.

FIG. 5 shows a device 3 which is a concretization of the device 3 shown in FIG. 3. The device 3 shown in FIG. 5 also comprises a device 4 for removing/extracting a core sample and a LIBS device 5 as a sample unit 11, a scanning unit 10 and an evaluation device (not shown). The device 3 is shown on a bottom surface 8 of a soil 1. A core sample 2 is shown. The depth t is also shown.

With the described methods and with the described device 3, a ground 1, for example an agricultural field or a construction ground to be examined for pollutants, can be analyzed. By means of an analysis by means of PGNAA, PFTNA and/or LIBS, the quality of the ground 1 can be determined efficiently and reliably in an area-wide manner.

### LIST OF REFERENCE SIGNS

1 soil/ground

2 core sample

3 device

4 device for removing/extraction of a core sample

5 LIBS device

6 sample site

7 scanning surface

8 bottom surface

9 evaluation device

10 scanning unit

11 sample unit

t depth

1. A method for determining an element composition of a ground depending on the depth, comprising:
extraction of a core sample of the ground, and
determining the element composition of the ground depending from the depth by analysis of the extracted core sample by Laser induced Breakdown Spectroscopy.

2. Method according to claim 1, wherein the core sample is analyzed during extraction.

3. An apparatus for determining an element composition of a ground depending on the depth, comprising:
a device for extracting of a core sample of the ground,
a Laser induced Breakdown Spectroscopy device for determining the element composition of the ground as depending on the depth by analysis of the extracted core sample by Laser induced Breakdown Spectroscopy.

4. A method for determining an element composition of a ground, comprising:
a) for at least one sample location, the ground is analyzed depending on the depth by a method according to claim 1, and/or
b) for a scanning surface, the ground is analyzed by scanning the ground by Prompt Gamma Neutron Activation Analysis, and/or Pulsed Fast Neutron Activation Analysis, and
c) determining the element composition of the ground based on the results of step a) and/or b).

5. Method according to claim 4, wherein both step a) and step b) are performed, and wherein in step c), the element composition of the ground is set based on the result of step a) and with correction based on the result of step b) or based on the result of step b) and with correction based on the result of step a).

6. Method according to claim 4, wherein a profile of the element composition of the ground is created, which covers the ground from a bottom surface to a depth in a range from 0.3 to 1 m.

7. Method according to claim 4, wherein in step a) and/or step b) a moisture of the ground is additionally determined and taken into account in the determination of the element composition of the ground.

8. Method according to claim 4, wherein furthermore at least one parameter of the ground is determined by Near Infrared Spectroscopy and/or by a camera.

9. Method according to claim 4, wherein the ground is an agricultural.

10. Apparatus for determining an element composition of a ground by a method according to claim 4, comprising:
a sample unit for extracting and analyzing core samples according to step a), and/or
a scanning unit for scanning the ground according to step b), and an evaluation device, which is configured to determine the element composition of the ground according to step c).

11. A method of treating an agriculturally used soil, comprising:
A) Determining an element composition of the soil by a method according to claim 1, and
B) location-dependent application of a fertilizer to the soil on the basis of a result from step A).
